(19) United States
(12) Patent Application Publication
(10) Pub. No.: US 2004/0085910 A1
(43) Pub. Date: May 6, 2004

(54) Media access control device for high efficiency ethernet backplane

(75) Inventor: Linghsiao Wang, Irvine, CA (US)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor V.N. Inc., Irvine, CA

(21) Appl. No.: 10/285,952

(22) Filed: Nov. 1, 2002

(51) Int. Cl. H04L 1/00

(52) U.S. Cl. 370/252

(57) ABSTRACT

A improved Media Access Control (MAC) module specification is presented. The MAC module specification includes configurable support for: a reduced minimum packet size, a reduced inter-frame-gap size, a reduced preamble, receive and transmit clock generation. Benefits may be derived from protocol overhead reductions. Processors adhering to the improved MAC module specification may exchange information at improved bandwidth efficiencies by directly interconnecting respective MAC modules to one another.

### FIELD OF THE INVENTION

The invention relates to inter-processor communications, and in particular to methods and apparatus for transferring data in backplane Ethernet applications between interconnected processors at improved efficiencies.

### BACKGROUND OF THE INVENTION

It is known to use Ethernet technologies in backplane applications to provide inter-processor interconnection between a group of processors of a larger system. A prior art example of such a system is described by Gallagher, et al. in U S. Pat. Nos. 5,971,804, 6,157,534, and 6,300,847 entitled “Backplane Having Strip Transmission Line Ethernet Bus” filed June 30^{th}, 1997, Aug. 17^{th}, 1999, and Sept. 11^{th}, 2000, respectively. The particular application provided for the interconnection of multiple computers to provide a multiprocessor server. The described solution makes use of the IEEE 802.3 standard Ethernet framing protocol for transferring data between multiple storage devices associated with the multiple computers making up the (aggregate) server computer system. Gallager et al. seek only to solve a cabling problem in collocating the individual computers to reduce footprint of the multiprocessor server computer. Although inventive, Gallager et al. seek only to comply with the IEEE 802.3 standard, further integration is not sought as the application calls for the use of interconnected hot-swappable computer modules. In complying with the standard Ethernet specification for physical interconnection at the physical layer (PHY), Gallager et al. provide a backplane printed circuit board having conductive traces of metallic composition and geometrically engineered to resemble electrical characteristics of coaxial cables used in providing data transport at the physical layer. Gallager et al. do not address issues related to Ethernet bandwidth utilization efficiency.

The advent of intelligent communications networks have enabled flexible provisioning of data services. Intelligent data network nodes typically provide: data transport in accordance with a multitude of data transport protocols, support for differentiated services, protocol translation, protocol encapsulation, etc. Legacy solutions include the use of multiple devices and complex wiring. However, recent advances and recent trends seek integration and miniaturization in search for higher processing speeds, higher data bandwidths, lower provisioning costs, lower power requirements, reduced footprint, etc.

The various devices providing the different functionality typically support IEEE 802.3 Ethernet based communications. The reduction thereof to single-chip-devices leads to inefficiencies related to device interconnectivity.

FIG. 1 is exemplary of the manner in which, prior art, standard IEEE 802.3 communications are provisioned.

A Media Access Control (MAC) module 102 associated with a processor 100 exchanges data via a Media Independent Interface (MII) 104 with a PHYsical layer adaptation module 106—all of which have definitions in the IEEE 802 standard. A variety of interfaces (104) are defined such as, but not limited to: Gigabit MII (GMII), Reduced MII (RMII), General Purpose Serial Interface (GPSI), etc. The PHY module 106 physically drives associated physical media 108 to transmit data signals and listens to the physical media 108 to receive data signals.

The history of the development of Ethernet technologies has a great influence on current the IEEE 802.3 Ethernet standard specification. Originally coaxial cable media 108 was used for Ethernet communications. Benefits were derived from the use of coaxial cables 108 which provided excellent noise rejection and the single wire solution did not suffer from crosstalk effects. Drawbacks included the need for an arbitration discipline as the coaxial cable (108) solution adopted was also used to provide support for a shared bus interconnection topology.

Making reference to FIG. 2, a variety of provisions were made with respect to the specification of the MAC module 102 in order to support shared bus communications in combination with the PHY module 106 between which:

A minimum packet size of 64 bytes: As the single wire coaxial cable (108) only supports half-duplex communications, the 64 byte minimum packet size (200) requirement provided for a predefined transmission time period during which other PHY modules 106 connected to the shared bus (coaxial cable 108) would make a determination as to whether the shared bus 108 was busy and thus unavailable. This is known as carrier event detection in accordance with a Carrier Sense Multiple Access (CSMA) shared bus arbitration discipline. The minimum length of the carrier event has an effect on the length of the coaxial cable (also referred to as media reach). Under packetized short message exchange conditions, the data payload 202 is padded (typically with zeros) to makeup for the difference between the real packetized message size and the 64 byte minimum packet length (200) requirement.

A 12 byte Inter-Frame-Gap (IFG): This requirement for silence between individual packet 200 transmissions is related to need for the minimum packet size. As stated in the IEEE 802.3 standard, after a packet transmission over the shared bus (108), a reset cycle (204) is required for the medium 108 to quiet down. This provides for the dissipation of transient signals travelling along the center conductor of the coaxial cable medium 108 used. The 12 byte inter-frame-gap 204 also made provisions for the receiving PHY 106 to finish processing the last received packet and ready itself for the next packet transmission. During the first third of the inter-frame-gap 204, the transmitting PHY 106 may still be able sense a feedback signal from the medium 108 remnant of the last transmitted packet 200 because of signal reflections in the coaxial cable medium 108. During last third of the inter-frame-gap 204, receiving PHY modules 106 ignore carrier detection and are allowed to go ahead with transmission if ready to do so. A possibility for collision exists when multiple PHY modules 106 sharing the bus (108) decide to transmit on detecting an idle bus 108. Upon detecting a collision event during transmission, each PHY module 106 affected must back-off for a random period of time before attempting to start transmission again. The random back-off is required to avoid a capture effect by which a closed group of nodes grab most of the bandwidth of the medium 108.

A 7 byte preamble followed by a lbyte Start-Of-Frame (SOF) delimiter: The preamble 206 is necessary because of the use of the single wire coaxial cable medium 108 as no provisions can be made for a separate clock signal in transferring the data. Receiving PHY modules 106 rely on the preamble 206 to detect a signal on the bus (108) and then lock on the detected signal. It used to take some time to achieve signal lock using legacy technology and therefore some preamble bytes are expected to be lost by PHY module 106. The 1 byte start-of-frame delimiter 208 signals the PHY module 106 to consider the following signal as data.

Clock signals (110 and 112) for both transfer directions across the MII interface 104 to be generated by the PHY module 106 (see FIG. 1): Reasons for this stipulation stem from the fact that: the PHY module 106 cannot transmit over the medium 108 unless the medium 108 is available despite the MAC module 102 having a packet ready for transmission, conversely the PHY module 106 can only transfer data to the MAC module 102 when a packet is being received over the medium.

In using Ethernet technologies for inter-processor communications, the above provisions for shared bus architecture support represent major drawbacks. There therefore is a need mitigate the effects of the above mentioned drawbacks.

### SUMMARY OF THE INVENTION

In accordance with an aspect of the invention, in improved Media Access Control (MAC) module is provided. The improved MAC module specification includes configurable support for: a reduced minimum packet size, a reduced inter-frame-gap size, a reduced preamble, receive and transmit clock generation. Benefits are derived from protocol overhead reductions, and from cost reductions in using the improved MAC modules to provide support for information exchange without utilizing PHYsical layer adaptation modules (PHY). The improved MAC module includes clock signal generators and clock signal drivers for each one of the transmit and receive paths, as well as enablers for: short frame generation, short frame reception, preamble compression, receive clock signal generation, and transmit clock signal generation. The improved MAC module further includes a byte removal specifier for specifying a number of bytes to be removed from the inter-frame-gap.

Processors adhering to the enhanced MAC module specification may exchange information at improved bandwidth efficiencies especially under short packet exchange conditions by directly interconnecting respective MAC modules to one another. The improved MAC design optimizes transmission and reception performance by reducing the traditional protocol overhead while maintaining interoperability.

### BRIEF DESCRIPTION OF THE DRAWINGS

The features and advantages of the invention will become more apparent from the following detailed description of the preferred embodiment(s) with reference to the attached diagrams wherein:

FIG. 1 is a schematic diagram showing a standard IEEE 802.3 physical connectivity;

FIG. 2 is a schematic diagram showing a standard IEEE 802.3 packet transmission signal mask;

FIG. 3 is a schematic diagram showing a MAC module adapted to generate clock signals in accordance with an implementation of the exemplary embodiment of the invention;

FIG. 4 is a schematic diagram showing interconnected MAC modules adapted to generate clock signals in accordance with another implementation of the exemplary embodiment of the invention;

FIG. 5 is a table showing a group of MAC module option definitions in accordance with an exemplary embodiment of the invention; and

FIG. 6 is a schematic diagram showing exemplary interconnected elements using enhanced MAC modules to achieve inter-processor Ethernet based interconnectivity in accordance with the exemplary implementations of the invention.

It will be noted that in the attached diagrams like features bear similar labels.

### DETAILED DESCRIPTION OF THE EMBODIMENT

Seeking to provide inter-processor communication, the use of Ethernet technologies suffers from the legacy provisions made in the MAC specification to support shared bus communications. Shared bus communications also share the communication bandwidth. An increased bandwidth is available while utilizing the same devices by adopting point-to-point inter-processor interconnectivity. Support for full-duplex communications between interconnected processors is also desired.

In accordance with a preferred embodiment of the invention, backplane applications using Ethernet technologies for inter-processor communications may derive benefits from the point-to-point interconnection topology. Point-to-point interconnectivity may further benefit from the elimination of, or the relaxation of, the stringent requirements for CSMA bus arbitration. A major part of the provisions for half-duplex bus arbitration is considered protocol overhead with respect to point-to-point interconnectivity, and if eliminated or relaxed, overall inter-processor communications efficiencies may be derived therefrom.

In accordance with the exemplary embodiment of the invention, bandwidth utilization may be reduced in conveying Ethernet packets between point-to-point interconnected processors reducing protocol overhead:

The requirement for standard 64 bytes minimum packet size (200) is relaxed: In the point-to-point interconnectivity environment, the transmission media is no longer shared and the minimum packet size requirement is no longer necessary because there is no need for collision detection. Relaxing the minimum packet size requirement, and perhaps eliminating it all together, reduces the protocol overhead. The benefits from the reduction in the protocol overhead stemming from relaxing the 64 byte minimum packets size requirement, may particularly be taken advantage of during packetized short message transmissions. A significant amount of (processing and transport) bandwidth is otherwise lost to padding.

Signal processing has been comparatively slow in the past. By utilizing point-to-point inter-processor communications, and given the signal processing capabilities available today, the full 12 byte inter-frame-gap 204 may be compressed to lower the protocol overhead and achieve higher bandwidth utilization efficiency especially in short packet exchange environments.

The 7 byte preamble 206 requirement may be relaxed in order to further improve bandwidth utilization performance. A reduction in the size of the preamble 206 is possible as current technology provides for faster signal lock. In the special case of point-to-point interconnection between two processors 100, without making use of standard Ethernet PHY modules 106, the 7 byte preamble may be reduced to a minimum size while ensuring adequate provisions for the start-of-frame delimiter detection.

In adopting these changes to the standard IEEE 802.3 MAC specification, further benefits are derived from a reduction in packet transfer latencies especially encountered in short message exchange environments

Typically embedded processors include integrated MAC modules 102. The provision for the generation of both of the receive 110 and transmit 112 clock signals from the PHY module 106, specified for standard GPSI or MII interfaces, further impedes the use of Ethernet technologies for inter-processor communications as both processors 100 interconnected via a point-to-point link need to further implement PHY modules 106. Each exchanged packet has to go through two PHY modules 106 since MAC-to-MAC interconnectivity is not possible as legacy MAC modules do not provide clock signal generation.

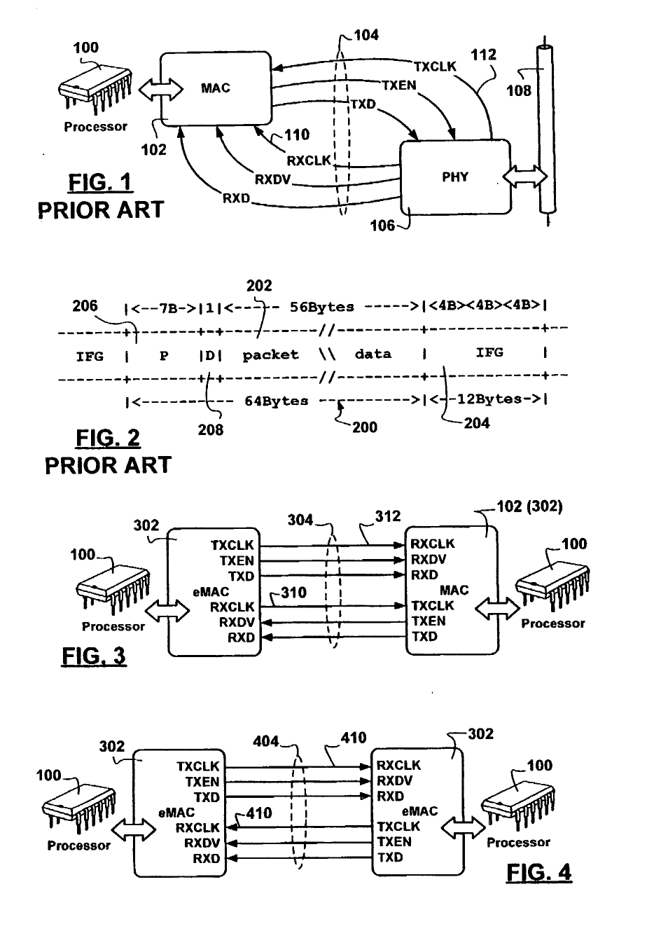

However, for backplane applications using point-to-point processor interconnection, benefits may be derived from eliminating the need to use PHY module 106. In accordance with the exemplary embodiment of the invention, an enhanced MAC (eMAC) module 302 presented is provided with configurable clock signal generation for the receive 310 and transmit 312 data paths separately. The eMAC module 302 therefore includes clock signal generators and clock signal drivers for each one of the receive and transmit paths. This ability enables the eMAC module 302 of a processor 100 to act as a PHY module when directly connected to another MAC module 102/302 of a peer processor 100. An exemplary eMAC-to-MAC interconnectivity scenario is presented in FIG. 3.

The eMAC module 302 may therefore be connected directly to a standard MAC module 102 as shown in FIG. 3 or another eMAC module 302 in accordance with the specification presented herein. In interconnecting two eMAC modules 302 clock signal generation may be shared between the interconnected eMAC modules 302, for example each eMAC module 302 generating a clock signal 410 for the respective data transfer out direction as shown in FIG. 4.

By providing clocking 410 for the transmit direction as shown in FIG. 4 the distance between the interconnected processors 100 (connectivity reach) can be extended further.

In accordance with an exemplary implementation of the invention, a configurable MAC design is provided. The configurable eMAC module 302 can be set via configuration specifiers to act as an IEEE 802.3 standard compliant MAC module 102 or as an enhanced MAC module 302. The configuration specifiers may also be referred to as option enablers.

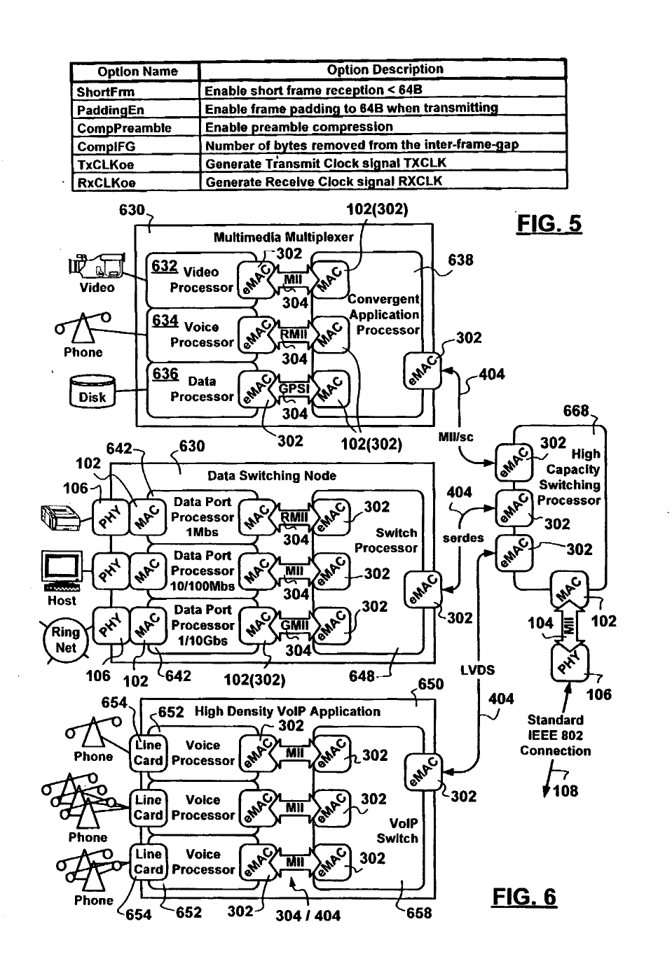

The table shown in FIG. 5 lists exemplary configurable options for the eMAC module 302 providing for the configuration of the standard limitations mentioned above. Support for configuration of each option may preferably be embedded in the control logic of each eMAC module 302.

Relaxing the minimum 64 byte packet size requirement 200 involves both the transmit and receive directions. Enabling the Short Frame (ShortForm) option directs the eMAC module 302 to expect receipt of an end-of-frame delimiter before the expiration of the standard 64 byte transmission time. Disabling the Padding Enable (PaddingEn) directs the eMAC module 302 to insert an end-of-frame delimiter in the data stream as soon as the packet payload has been transmitted. For backward compatibility with the standard IEEE 802.3 MAC specification, only PaddingEn need be enabled so that all the transmitted packets will be at least 64 bytes long.

Enabling the preamble compression (CompPreamble), the enhanced MAC module 302 is directed to use a single byte preamble (206) and the start-of-frame delimiter 208 to signal packet transmission starts.

In relaxing the inter-frame-gap requirement via the inter-frame-gap compression (CompIFG) option, a number of bytes to be removed must be specified.

The generate transmit clock signal (TxCLKoe) and the generate receive clock signal (RxCLKoe) options when enabled direct the enhanced MAC module to drive the TXCLK 310 and RXCLK 312 lines of the modified interface 304.

Except for the CompIFG option, all other options may be efficiently implemented via configuration bits or configuration flags using methods well known to a person of skill in the art. The CompIFG option may utilize a number of configuration bits to specify the number of bytes to be removed from the inter-frame-gap. With the standard specified inter-frame-gap of 12 bytes, a maximum number of 4 bits are necessary to express the number of bytes to be suppressed. A lower number of bits may be used (3 bits) if provisions for an inter-frame-gap, albeit reduced, need be retained.

Combinations of each of the configurable options may be activated depending on requirements of the particular application for which the enhanced MAC module 302 is used. FIG. 6 shows exemplary scenarios in which the enhanced MAC module is used in accordance with an exemplary implementation of the invention.

In accordance with a first exemplary implementation of the invention, a multimedia multiplexer 630 is shown in FIG. 6. Multimedia application specific processors 632, 634, and 636 receive signals from a video camera, a phone, and a storage device respectively. Each processor 632/634/636 processes the corresponding application specific signal and exchanges the processed signal with a convergent application processor 638. In accordance with the exemplary embodiment of the invention, each multimedia application specific processor 632/634/636 makes use of Ethernet technologies to connect to the convergent application processor 638 point-to-point. For this purpose, each multimedia application specific processor 632/634/636 employs an enhanced MAC module 302 and drives the clock signals of the corresponding interface 304. Trhe convergent application processor 638 need only implement standard MAC modules. For increased efficiency in the convergent application processor 638 needs to employ enhanced MAC modules 302. All protocol overhead reduction options presented in FIG. 5 may be activated especially for embedded solutions wherein all processors 632, 634, 636, and 638 are soldered on a single printed circuit board within close proximity of each other.

In accordance with a second exemplary implementation of the invention, a data switching node 640 is also shown in FIG. 6, Data port processors 642 receive data via standard MAC modules 102 from exemplary attached devices, network nodes, or data transport networks. Each data port processor 642 may provide a variety of services between which, but not limited to: connection speed adaptation, protocol encapsulation, protocol translation, etc. In accordance with the exemplary embodiment of the invention, each data port processor 642 makes use of Ethernet technologies for point-to-point backplane connectivity with a switch processor 648. For this purpose, each data port processor 642 (exemplary) employs a standard MAC module 102. The switch processor 648 employs enhanced MAC modules 302 to achieve inter-processor interconnectivity. Each eMAC module 302 associated with the switching processor 648 drives clock signals associated with the corresponding interfaces 304. For increased efficiency the data port processors 642 need to employ enhanced MAC modules 302. All protocol overhead reduction options presented in FIG. 5 may be activated especially for embedded solutions wherein all processors 642, and 648 are soldered on a single printed circuit board within close proximity.

In accordance with a third exemplary implementation of the invention, a high density Voice over Internet Protocol (VoiP) concentrator 650 is shown in FIG. 6. Voice processors 652, via line card adapters 654 exchange voice signals with corresponding telephone sets. Each voice processor 652 processes voice signals and exchanges VoIP packets with a VoIP switch 658. In accordance with the exemplary embodiment of the invention, each voice processor 652 make use of Ethernet technologies for backplane point-to-point connectivity with the VoIP switch 658. The voice processors 652 and the VoIP switch 658 make use of enhanced MAC modules 302 to exchange VoIP packets over corresponding interfaces 304/404. All protocol overhead reduction options presented in FIG. 5 may preferably be activated as VoIP applications typically make extensive use of short packet exchanges.

For comparison, exchanging VoIP packets having a 16 byte voice payload and 16 bytes control overhead in accordance with the standard IEEE 802.3 Ethernet specification would correspond to an 84 byte transmission time. With all protocol overhead reduction options active, it would only require 57 bytes of transmission time. This reduction represents a 32% improvement. The transmission overhead is reduced to only 25 bytes from the standard 52 bytes of standard Ethernet transmission overhead.

In connecting enhanced MAC module 302 to standard modules 102, the enhanced MAC modules 302 would look to the corresponding MAC modules 102 like standard PHYs.

In interconnecting the processors 632/634/636, 642, and 652 with the processors 638, 648, and 658 respectively using enhanced MAC modules 302 on both sides of the point-to-point backplane interconnections, all options presented in FIG. 5 may be activated to maximize data transfer efficiency. All enhanced MAC modules 302 will be: able to keep up with short inter-frame-gaps, able to receive packets only one byte preamble, and able to receive shorter than standard frames.

The exemplary implementations presented above may be further integrated into larger systems. For example each one of the above implementations is an interface card for use in a card rack. In accordance with a fourth implementation of the invention, Ethernet technologies may be further used in interconnecting interface cards to a high capacity switching processor 668 point-to-point. Even in a card rack solution the processors 638, 648, 658, and 668 may benefit from the use of enhanced MAC modules 302. Depending on the physical size of the overall system, the inter-connection between the processors 638, 648, 658, and 668 may be relatively long in which case clock signals may preferably (but not necessarily) be generated by each eMAC module 302 and the interface 404 may be a serializer/deserializer (serdes) or a Low Voltage Differential Signaling (LVDS) compliant interface enabling an extended point-to-point reach. Depending on the implementation, using a buffered MII interface 404 with clock signals 410 running along the respective transmit directions will work well enough.

Benefits from protocol overhead reductions may be enjoyed by the activation of the protocol overhead reduction options presented in FIG. 5. The transmission overhead in the overall system is therefore minimized improving overall system performance. Minimized frame size, shorter preamble, and shorter inter-frames gaps also provides for shorter transmission times and shorter queuing latencies in exchanging small size messages/packets. If the use of a standard Ethernet PHY functionality is needed, only the preamble compression need be disabled.

If connecting to a standard Ethernet environment outside of the overall system presented in FIG. 6 standard Ethernet compliance may be needed and all the protocol overhead reduction options shall best be disabled.

The embodiments presented are exemplary only and persons skilled in the art would appreciate that variations to the above described embodiments may be made without departing from the spirit of the invention. The scope of the invention is solely defined by the appended claims.

I claim:

1. A Media Access Control (MAC) module comprising clock signal generator to support MAC module to MAC module interconnection.

2. A MAC module as claimed in claim 1, wherein the clock signal generator further includes a receive clock signal generator.

3. A MAC module as claimed in claim 2, wherein the clock signal generator further includes a receive clock signal driver.

4. A MAC module as claimed in claim 2, wherein the clock signal generator further includes a receive clock signal generation enabler.

5. A MAC module as claimed in claim 1, wherein the clock signal generator further includes a transmit clock signal generator.

6. A MAC module as claimed in claim 5, wherein the clock signal generator further includes a transmit clock signal driver.

7. A MAC module as claimed in claim 5, wherein the clock signal generator further includes a transmit clock signal generation enabler.

8. A Media Access Control (MAC) module comprising means for protocol overhead reductions.

9. A MAC module as claimed in claim 8, wherein the means for protocol overhead reduction further includes a short frame generator.

10. A MAC module as claimed in claim 9, wherein the short frame generator further includes a short frame generation enabler.

11. A MAC module as claimed in claim 8, wherein the means for protocol overhead reduction further includes a short frame receiver.

12. A MAC module as claimed in claim 11, wherein the short frame receiver further includes a short frame reception enabler.

13. A MAC module as claimed in claim 8, wherein the means for protocol overhead reduction further includes a short inter-frame-gap generator.

14. A MAC module as claimed in claim 13, wherein the short inter-frame-gap generator further comprises a byte removal specifier, specifying a number of bytes to be removed from the inter-frame-gap.

15. A MAC module as claimed in claim 8, wherein the means for protocol overhead reduction further includes a preamble compressor.

16. A MAC module as claimed in claim 15, wherein the preamble compressor further includes a preamble compression enabler.
